(19) United States
(12) Patent Application Publication
(10) Pub. No.: US 2026/0044711 A1
(43) Pub. Date: Feb. 12, 2026

(54) SYSTEMS AND METHODS FOR GENERATING ACTION-ORIENTED ENTERPRISE OUTPUTS BASED ON SPATIAL MEMORY AND MULTI-AI ORCHESTRATION

(71) Applicant: ACCENTURE GLOBAL SOLUTIONS LIMITED, Dublin 4 (IE)

(72) Inventors: Gakuse HOSHINA, Tokyo (JP); Tatsuya Sakuma, Tokyo (JP); Mitsuyasu Sasaki, Tokyo (JP); Qifeng Cao, Tokyo (JP)

(73) Assignee: ACCENTURE GLOBAL SOLUTIONS LIMITED, Dublin 4 (IE)

(21) Appl. No.: 19/293,923

(22) Filed: Aug. 7, 2025

Related U.S. Application Data
(60) Provisional application No. 63/681,468, filed on Aug. 9, 2024.

(51) Int. Cl. G06N 3/045; G06N 3/0442; G06N 3/08

(52) U.S. Cl. CPC G06N 3/045; G06N 3/0442; G06N 3/08

(57) ABSTRACT

Methods and systems for generating action-oriented enterprise outputs are disclosed. Multi-modal input data from input data sources are received. Historical data corresponding to enterprise solutions associated with historical input is converted into short-term, long-term, and spatial memory using connectors that interface with artificial intelligence (AI) models. Features are extracted from the multi-modal input data and the historical data. Trends are determined from the extracted features associated with the multi-modal input data and the historical data. A subsequent event is predicted based on the trends using a transformer-based Large Language Model (LLM). At least one action-oriented enterprise output is generated based on the predicted subsequent event.

### CROSS-REFERENCE TO RELATED PATENT APPLICATIONS

This application claims priority to U.S. Provisional Application No. 63/681,468, filed on Aug. 9, 2024, the entire content of which is hereby incorporated by reference in the entirety for all purposes.

### TECHNICAL FIELD

The present disclosure generally relates to Artificial-Intelligence (AI) and Machine-learning (ML) architectures and, more particularly, to AI-based systems that combine short-term, long-term, and spatial memories in order to interpret intentions from heterogeneous multi-modal inputs and to orchestrate multiple AI models or enterprise Application Programming Interfaces (APIs) for producing outputs that stimulate subsequent human or machine actions.

### BACKGROUND

Artificial intelligence (AI) is increasingly employed with the ongoing digital transformation across various sectors. For example, AI is used in performing various operations including data analysis, automate decision-making processes, and complex computational tasks. To perform such operations, processing large volumes of heterogeneous data originating from multiple input sources and formats, including structured data and unstructured data, is required. In response to growing operational complexity and data diversity, there has been a shift towards utilizing AI-based components to handle specific analytical or functional tasks across distributed environments. However, due to the increasing specialization and variety of AI models, an AI based system using a single AI model may be often insufficient to process all categories of inputs or to satisfy varying system objectives.

Further, the AI based system may fail to support coordinated execution, dynamic selection, or seamless switching among multiple AI models based on the nature of a given input or a task, as the single AI based system relies on static configurations and predefined model associations, limiting flexibility and responsiveness to evolving requirements. Moreover, integration of multiple AI models into the AI based system may be often hindered by compatibility constraints, lack of standardized interfacing, and absence of orchestration mechanisms that are capable of managing inter-model interactions. The rapid development cycle of AI technologies further introduces challenges, as new models may offer enhanced performance or capabilities that the AI based system cannot readily adopt.

### SUMMARY

This summary is provided to present, in simplified form, selected concepts that are further described in the Detailed Description. It is not intended to identify key features or delimit the scope of the claims.

In one aspect, the present disclosure provides a control system that interprets intentions from multi-modal inputs to generate enterprise outputs. The system ingests texts, conversation logs, audio streams, images, videos, and sensor data, storing the raw text and binary content meta-data in a short-term memory. Via a connector layer the system invokes one or more AI models that transform the short-term memory into a summarized and normalized long-term memory. The long-term memory is further converted—again through AI models—into a structured spatial memory organized along feature axes such as time, location, actor, action, and motivation. Features and historical correlations are extracted from the spatial memory; sequences with similar behavior are clustered to derive trends; and a transformer-based event-prediction model is trained on the trend data. Using the resulting model, the system predicts forthcoming events, formulates and verifies hypotheses against archived spatial memory, and records the verified hypotheses in a layer-structured meta-memory.

Based on predicted events and verified hypotheses, the system autonomously selects—through the same connector layer—one or more authorized AIs or enterprise APIs, executes them, and delivers at least one output (e.g., a report, spreadsheet, code snippet, or robotic-process instruction). Each output is validated by a Responsible-AI module to mitigate bias, hallucination, or policy violation. In this manner, the disclosed architecture unifies intention interpretation, memory management, and dynamic AI orchestration to expand machine capabilities and facilitate subsequent human or system decisions.

In another aspect, the present disclosure relates to a non-transitory computer readable medium including machine-executable instructions that may be executable by a processor to perform the method as discussed herein.

It is appreciated that method in accordance with the present disclosure can include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 is a block diagram illustrating an example control system that integrates short-term, long-term, and spatial memories and orchestrates multiple Artificial Intelligence (AI) models or enterprise Application Programming Interfaces (APIs), in accordance with embodiments of the present disclosure.

FIG. 2 is a high-level process flow showing how the control system interprets and executes intent from heterogeneous multi-modal inputs to generate enterprise outputs, in accordance with implementations of the present disclosure.

FIG. 3 is a detailed flowchart of an example method for extracting Five-Ws features, bundling trends, and predicting a subsequent event by means of a transformer-based model, in accordance with implementations of the present disclosure.

FIG. 4 is a flowchart illustrating how prediction results produced by the transformer-based event-prediction model are stored in prediction history for continuous learning and auditability, in accordance with implementations of the present disclosure.

FIG. 5 is a flowchart illustrating a method for training a model for predicting a next event using features and trends extracted from a spatial memory, in accordance with implementations of the present disclosure.

FIG. 6 is a flowchart illustrating a method for extracting features and trends from a plurality of inputs and using a hypothesis and verification to make collective knowledge a meta-memory, in accordance with implementations of the present disclosure.

FIG. 7 is a process flow diagram illustrating an exemplary method in which a push action agent actively prompts human or system to perform actions using past memories stored in a spatial memory and hypotheses stored in a meta memory extracted from the past memories, in accordance with an embodiment of the present disclosure.

FIG. 8 is a flow diagram that presents an example method for generating enterprise outputs from multi-modal inputs in accordance with implementations of the present disclosure.

FIG. 9 illustrates an example computer system to implement the control system disclosed in the example system of FIG. 1, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series, and the like.

The term “a”means “one or more”unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A. and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

Implementations of the present disclosure provides a system and method for interpreting and executing intent from multi-modal input data to generate enterprise outputs (also referenced to as enterprise solutions) including enterprise-level outputs. For generating the enterprise outputs, data from input data sources, including but not limited to text documents, conversation logs, voice logs, image logs, and video logs may be received and stored in a short-term memory. Through connectors interfacing with various Artificial Intelligence (AI) models, the short-term memory may be converted and stored into a summarized and organized long-term memory, which is further structured into a spatial memory using the AI models through the connectors. Further, features including temporal, spatial, contextual, causal, and entity-related attributes from both the multi modal input data and historical data may be extracted. Based on the features, trends may be determined and stored in the spatial memory, and further a transformer-based event prediction model may be trained. Based on the learned trends, upcoming events may be predicted, hypotheses may be formulated and verified using historical data, and a layer-structured meta-memory may be generated to guide proactive decision-making. Further, implementations of the present disclosure may enable execution of enterprise-approved AIs and Application Programming Interfaces (APIs) based on the predicted events, enabling dynamic output generation such as reports, spreadsheets, code, or robotic process automation configurations. Such a coordination of internal and external systems may result in improved accuracy, responsiveness, and actionability of enterprise decisions, while ensuring that enterprise-level outputs are validated for ethical considerations and hallucination risk.

To summarize, the multi-modal input data (e.g., including text, voice, image and video) may be received, processed, and interpreted in order to dynamically generate ethically informed enterprise outputs. Implementations may enable to employ the transformer-based event prediction model to extract temporal, spatial, contextual, causal, and entity-related features from both the multi-modal input data and historical data, which may be used in identifying trends and predicting subsequent events. Such predictions may be organized into the layer-structured meta-memory for improved decision-making and proactive action planning.

Implementations enable utilization of the short-term and the long-term memory, as well as the spatial memory, thereby allowing the AI models to coordinate with multiple external APIs and enabling the AI models to handle complex tasks beyond the scope of a single AI agent. As a result, implementations of the present disclosure may enhance processing speed through distributed coordination, improve accuracy and reliability via trend-based prediction and hallucination detection, and provide efficient memory management through structured long-term memory conversion and spatial organization. Furthermore, implementations integrate ethical considerations into its output, cross-validating outputs using historical patterns and predefined parameters, thus ensuring a trustworthy and context-aware automation for enterprise-level decision-making.

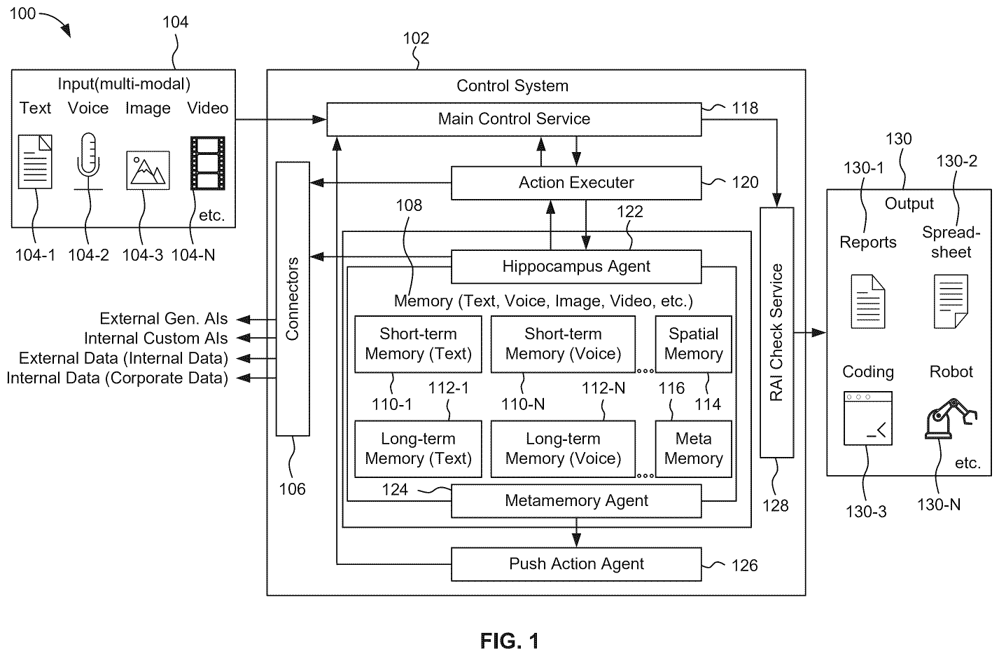

FIG. 1 is a block diagram illustrating an example control system that integrates short-term, long-term, and spatial memories and orchestrates multiple Artificial Intelligence (AI) models or enterprise Application Programming Interfaces (APIs), in accordance with implementations of the present disclosure. The exemplary system 100, depicted in FIG. 1, includes a control system 102, multi-modal input data 104 received from various input data sources, and connectors 106. The control system 102 includes a memory 108 including a short-term memory 110 (short-term memory (text) 110-1, and short-term memory (voice) 110-N), long-term memory 112 (long-term memory (text) 112-1, and long-term memory (voice) 112-N), a spatial memory 114, and a meta memory 116. The control system 102 further includes a main control service 118, an action executer 120, a hippocampus agent 122, a metamemory agent 124, a push action agent 126, and a Responsible AI (RAI) check service 128. For brevity, only one control system 102 is depicted in FIG. 1. However, in some implementations, the exemplary system 100 may include multiple control systems.

In some implementations, the input data sources may also be referenced to as heterogeneous upstream data repositories. Examples of the input data sources may include enterprise applications, databases, servers, cloud platforms, repositories, Customer Relationship Management (CRM) systems, websites, service history databases, Internet-of-Things (IoT) platforms, customer support platforms, management systems, and/or the like. The input data sources may store the multi-modal input data 104. The multi-modal input data 104 may be structured data, semi structured data, and/or unstructured data. Non-limiting examples of the structured data, the semi-structured data, and the unstructured data may include structured tables, semi-structured documents (e.g., JavaScript Object Notation (JSON) or Extensible Markup Language (XML) documents), and unstructured textual or multimedia content.

The multi-modal input data 104 may include one or more of text data 104-1, voice logs 104-2, image logs 104-3, video logs 104-N, and/or the like. Examples of the multi-modal input data 104 may include, but are not limited to, enterprise documents, chat logs, customer support transcripts, emails, voice call recordings, Closed-Circuit Television (CCTV) or surveillance video feeds, user interaction logs from mobile or web applications, sensor data, social media content, and/or uploaded images.

The voice logs 104-2 may include speech-to-text (STT) data and raw audio data, while image logs 104-3 may include context information, image tag metadata, and image data. Similarly, the video logs 104-N may include video tag data, video content, and contextual information extracted from recorded or streaming footage. Further, the voice logs 104-2 may be captured via one or more microphones integrated into user devices, communication systems, or IoT-enabled environments. The image logs 104-3 may be obtained from still images captured through cameras, scanners, or other imaging devices. The video logs 104-N may be acquired from continuous video streams or recorded footage, such as movies, surveillance cameras, or screen recordings.

For example, the control system 102 may extract STT summary data and audio data pointers from the voice logs 104-2, context summary data and image data pointers from the image logs 104-3, and context summary data and video data pointers from the video logs 104-N. The preprocessed and indexed data is leveraged for downstream feature extraction, trend analysis, and prediction.

In an embodiment, the control system 102 may be a server system. Some examples of the server systems may be, but are not limited to, a cloud server, a centralized server, a rack server, a network server, a computer-based server, on premise server, a dedicated server, a remote server, and the like. In some examples, the control system 102 may be implemented as an on-premises system that is operated by an enterprise or a third-party engaged in cross-platform interactions and data management. In some examples, the control system 102 may be implemented as an off-premises system (for example, a cloud or an on-demand system) that is operated by an enterprise or a third-party on behalf of an enterprise. In some examples, the control system 102 may be implemented in a cloud environment. For simplicity, the control system 102 depicted in FIG. 1 may be a cloud environment that is intended to represent various forms of servers including a web server, an application server, a proxy server, a network server, a server pool, and/or the like. Furthermore, in some other implementations, the control system 102 may be implemented by way of a single device or a combination of multiple devices that may be operatively connected or networked together. The control system 102 may be implemented in hardware or a suitable combination of hardware and software.

The control system 102 includes a processor (not shown in FIG. 1). In some implementations, the control system 102 includes more than one processor. The processor may include, for example, microprocessors, microcomputers, microcontrollers, digital signal processors, central processing units, state machines, logic circuits, and/or any devices that manipulate data or signals based on operational instructions. The processor may execute machine-readable program instructions stored in a memory (not shown in FIG. 1) for generating the enterprise solutions. Execution of the machine-readable program instructions by the processor may enable the control system 102 to perform one or more operations described herein related to the interpreting intentions from multiple inputs for generating enterprise solutions. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

Further, the control system 102 may include a memory 108 including a short term-memory 110 (including short term memory data 110-1-110-N), a long-term memory 112 (including long term memory data 112-1-112-N), a spatial memory 114, and a meta memory 116.

In some embodiments, the short-term memory 110 stores large binary data corresponding to the multi-modal input data 104 such as the text data 104-1, the voice logs 104-2, the image logs 104-3, the video logs 104-N in separate storage systems, with only their corresponding storage paths and metadata retained in a non-relational database for fast reference and retrieval. The long-term memory 112 retains standardized, structured data and core feature keywords in the non-relational database, enabling semantic-level search and feature-based aggregation. The spatial memory 114 is initially organized by “Five Ws”, for example When, Where, Who, What, and Why (optionally including How), in a time-series format and stored in a Relational Database (RDB) data mart. During subsequent hypothesis formulation, additional axes may be introduced to enhance multi-dimensional analysis, and the “Five Ws” are reapplied across the new axes. The structured data in the spatial memory 114 captures relationships between entities along the timeline, allowing for efficient trend bundling by extracting and grouping data from the RDB for each time and location unit. As a result, brute-force processing over large datasets is avoided, enabling scalable analysis of temporal and contextual trends.

In an exemplary embodiment, the control system 102 receives the multi-modal input data 104 from the various input data sources. The multi-modal input data 104 may include, but are not limited to, the text data 104-1, the voice logs 104-2, the image logs 104-3, the video logs 104-N, and/or the like. The raw binary input data (multi-modal input data 104 in a raw form) is stored in a storage and meta-data stored in short-term memory 110, while metadata and access paths are retained for efficient lookup. The control system 102 further employs Artificial Intelligence (AI) models via the connectors 106 to transform the short-term memory 110 into summarized and organized long-term memory 112. The long-term memory 112 is then structured into the spatial memory 114 using the AI models. The control system 102 extracts one or more features from the multi-modal input data 104 and correlates the multi-modal input data 104 with historical trends stored in the spatial memory 114. These features and trends are used to train a transformer-based subsequent event prediction model, enabling accurate forecasting of future events.

The connectors 106 may connect the control system 102 to multiple systems or AI models (AIs) such as external Generative AI models (Gen AIs), internal custom AI models (internal custom AIs), external data (Internet data), and internal data (enterprise/corporate data). The connectors 106 facilitate integration, data exchange, and cooperation between the control system 102 and the multiple systems or AI models to generate the enterprise outputs efficiently. The external Gen AIs are cloud-based or third-party AI services capable of generating text, images, or other outputs. For example, the control system 102 may use an external Gen AI such as OpenAI's GPT-4 to generate enterprise reports or suggest action items based on a customer support transcript. The internal custom AI models are proprietary AI models developed and trained within the enterprise to address specific enterprise requirements or domain-specific tasks. For example, an internal fraud detection AI model that analyzes transactional data and flags anomalies specific to the enterprise's operating region or rules. The external data sources (internet data) are publicly available or licensed external datasets from the web or third-party APIs. For example, the control system 102 may retrieve live market trends, weather data, or news articles via public APIs or enterprise APIs to enrich the decision-making process. The internal data sources (enterprise data) include private, secure databases and knowledge repositories maintained within the enterprise. For example, internal CRM databases, Enterprise Resource Planning (ERP) logs, or employee performance records may be accessed to generate Human Resources (HR) reports, inventory forecasts, or automated workflows.

The AI models of the control system 102 determine intention based on various input data such as not only text but also images and sounds and works based on past memory (processing results) or historical data while collaborating with multiple external AIs and data through the connectors 106. The control system 102 dynamically generates output that takes human ethics into account. There are two key features of the control system 102: (1) The AI models in charge of the command chain works in cooperation with multiple other AIs to formulate subsequent action plans and carry out tasks based not only on external input but also on active suggested instructions from past memory, and (2) The control system 102 actively encourages to take action using accumulated past memory and hypotheses extracted and verified from that memory.

The control system 102 further includes various modules such as a main control service 118, an action executor 120, a hippocampus agent 122, a metamemory agent 124, a push action agent 126, and a Responsible AI (RAI) check service 128. The main control service 118 acts as the central coordination engine that manages the flow of data and control signals across the control system 102. The main control service 118 is responsible for receiving the multi-modal input data 104 from various input sources, coordinating with internal modules, and interfacing with various external AI systems and APIs through the connectors 106. The main control service 118 interprets user intent, formulates action plans based on the multi-modal input data 104 and the historical data, and dynamically modifies the action plans in real time based on feedback from external systems. The historical data may be associated with historical inputs and may be retrieved from the connectors 106 through the AI models. The main control service 118 further queries a catalog database of available AI services to identify and trigger the appropriate API or AI execution corresponding to a predicted or detected event. Additionally, the main control service 118 interfaces with the push action agent 126 to trigger proactive suggestions when a verified hypothesis is matched or aligned.

The action executor 120 serves as an operational mediator between the main control service 118 and the analytical subsystems, including the hippocampus agent 122 and the metamemory agent 124. The action executor 120 is responsible for routing data and control instructions between components, executing commands derived from interpreted user intent, and returning processed results to an orchestration layer. The action executor 120 enables the execution of action plans, the aggregation of response data from AI components, and the delivery of results for ethical review or further transformation.

The hippocampus agent 122 performs memory-based feature extraction and subsequent-event prediction based on both the multi-modal input data 104 and the historical data. The hippocampus agent 122 extracts semantic features including temporal, spatial, causal, contextual, and entity-specific attributes from the multi-modal input data. The hippocampus agent 122 also predicts subsequent events by leveraging a transformer-based large language model (LLM), which has been trained using previously extracted trends and patterns stored in the spatial memory 114. The predictions generated by the hippocampus agent 122 are used to guide the control system 102 in formulating enterprise solutions or initiating automated processes.

The metamemory agent 124 is responsible for managing and querying the meta-memory 116, a structured memory layer that stores verified hypotheses abstracted from long-term trends and historical patterns. The metamemory agent 124 generates candidate hypotheses based on trends extracted from spatial memory and historical data. The metamemory agent 124 validates the hypotheses by cross-referencing the candidate hypotheses with previously stored data patterns or historical data patterns within the spatial memory to determine their consistency and relevance. For each candidate hypothesis, the metamemory agent 124 assigns a confidence score that reflects its alignment with historical behavioral, contextual, and causal patterns.

The push action agent 126 is configured to query the meta-memory 116 to identify whether any verified hypotheses align with recent data stored in the spatial memory 114. Upon detecting a correlation between the most recent input data and a previously validated hypothesis, the push action agent 126 determines that a relevant event condition has been met. In response, the push action agent 126 proactively notifies the main control service 118 to initiate the execution of a suitable action plan. The execution may include retrieving and invoking an appropriate API or AI service from a catalog database to address identified scenario. By continuously monitoring for matched hypotheses and triggering actions based on real-time data alignment, the push action agent 126 enables the control system 102 to initiate intelligent, context-aware actions without explicit user input, thereby enhancing system autonomy and responsiveness.

Based on the executed action plan, the main control service 118 may generate output data 130 as the enterprise solution including an ethical consideration data. The output data 130 may include a wide range of actionable deliverables such as strategic reports 130-1 (e.g., performance summaries or operational insights), financial or operational spreadsheets 130-2, automatically generated scripts or software code modules 130-3, or configuration data for robotic process automation 130-N, to a user. The output data 130 may be formatted and transmitted through designated enterprise interfaces, user dashboards, system APIs, or workflow automation tools, depending on the target deployment environment.

The RAI check service 128 evaluates the output data 130 (e.g., the enterprise solution) to ensure alignment with ethical, legal, and enterprise-specific compliance standards. The RAI check service 128 performs validation checks on the generated output data 130 by assessing the output data 130 for issues such as bias, harmful language, hallucinated information, or sensitive data leakage. The RAI check service 128 also cross-references the output data 130 against predefined ethical parameters and historical processing results to detect inconsistencies or deviations from acceptable norms. In the event of a detected anomaly or violation, the RAI check service 128 is capable of correcting, filtering, or flagging the output before the output is finalized and delivered. The verification process ensures that all outputs are trustworthy, explainable, and aligned with RAI principles, thereby reinforcing operational safety and governance.

Though few components and subsystems are disclosed in FIG. 1, there may be additional components and subsystems which is not shown, such as, but not limited to, ports, network devices, databases, network attached storage devices, assets, machinery, instruments, facility equipment, emergency management devices, image capturing devices, cooling devices, heating devices, compressors, any other devices, and combination thereof. The person skilled in the art should not be limiting the components/subsystems shown in FIG. 1.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, Bluetooth adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the control system 102 as is unique to the present disclosure or necessary for an understanding of the present disclosure is depicted and described. The remainder of the construction and operation of the control system 102 may conform to any of the various current implementations and practices that were known in the art.

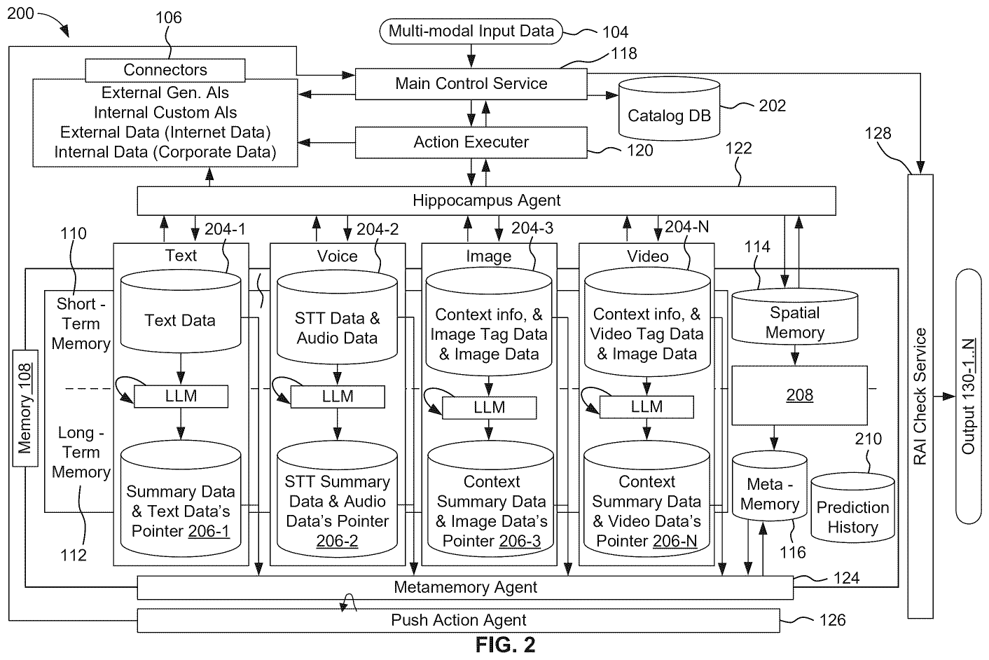

Various examples of generating the enterprise solutions are described in conjunction with FIGS. 2-9.

FIG. 2 is a high-level process flow showing how the control system interprets and executes intent from heterogeneous multi-modal inputs to generate enterprise outputs, in accordance with implementations of the present disclosure. FIG. 2 is explained in conjunction with FIG. 1. The process flow 200 may be executed within the system 100.

The process flow 200 includes receiving multi-modal input data 104 from input data sources including but not limited to text data, voice logs, image logs and video logs through the main control service 118 that functions as a central orchestration module of the control system 102.

The short-term memory 110 stores the multi-modal input data 104, which includes text data 204-1, Speech-to-Text (STT) data and corresponding audio data 204-2, context information and image tag metadata along with image data 204-3, and contextual information and video tag metadata along with video data 204-4. The long-term memory includes structured and summarized representations of the raw data originally stored in the short-term memory. The long term memory 112 includes summary data and pointers to text data 206-1, STT summary data and pointers to audio data 206-2, context summary data and pointers to image data 206-3, and context summary data and pointers to video data 206-N.

Further, the received multi-modal input data 104 is forwarded to the hippocampus agent 122 via the action executor 120, which serves as a dynamic task dispatching unit. The hippocampus agent 122 may perform feature extraction by analysing the multi-modal input data 104 in combination with historical data (prediction history 210) retrieved via the connectors 106. The hippocampus agent 122 extracts features including temporal features, spatial features, contextual features, causal relationships, and entity-related attributes. The features are stored into the spatial memory 114 to construct a structured, time-series data representation. The hippocampus agent 122 leverages a transformer-based subsequent event prediction model 208 integrated with a collective intelligence framework to predict one or more subsequent events. The one or more subsequent events may be predicted based on patterns and trends derived from the extracted features and correlations between the historical data. The prediction results are processed back to the main control service 118 through the action executor 120.

The main control service 118 then evaluates whether the predicted event necessitates execution of an enterprise action or action plan. If execution is required, the main control service 118 retrieves an appropriate external or internal AI model, API, or service from a catalog database 202 and initiates the execution of the action plan. The resulting output data 130 from the execution such as a report, spreadsheet, executable code, or robotic process automation (RPA) configuration may be considered as an enterprise solution. The output data 130 may be further validated by the RAI check service 128, which ensures that the generated output or the enterprise solution complies with predefined ethical parameters, regulatory standards, and internal governance policies. The RAI check service 128 analyzes the output data 130 to detect potential inconsistencies, hallucinations, sensitive content, or harmful instructions and performs any necessary corrections before final delivery. In parallel, the metamemory agent 124 continuously analyzes the historical data and the trends stored in the spatial memory 114 to formulate and verify one or more candidate hypotheses. The hypotheses are generated by correlating extracted trends with historical data patterns, and each hypothesis is assigned with a confidence score based on the degree of alignment with previously validated enterprise outcomes. The verified hypotheses are stored in a structured meta-memory 116, which supports higher-order abstract reasoning.

Further, the push action agent 126 periodically queries the meta-memory 116 to determine whether any verified hypotheses align with the most recent input features or data fluctuations. Upon detecting a match indicating that a previously confirmed pattern is reoccurring in real time, the push action agent 126 proactively signals the main control service 118. The signal triggers the selection and execution of a corresponding AI/API module suitable for the matched scenario, again subject to ethical validation through the RAI check service 128. The continuous feedback loop enables the control system 102 to autonomously generate and validate enterprise solutions by reasoning over multi-modal data, historical trends, and confirmed hypotheses, thereby enhancing operational intelligence and proactive decision-making.

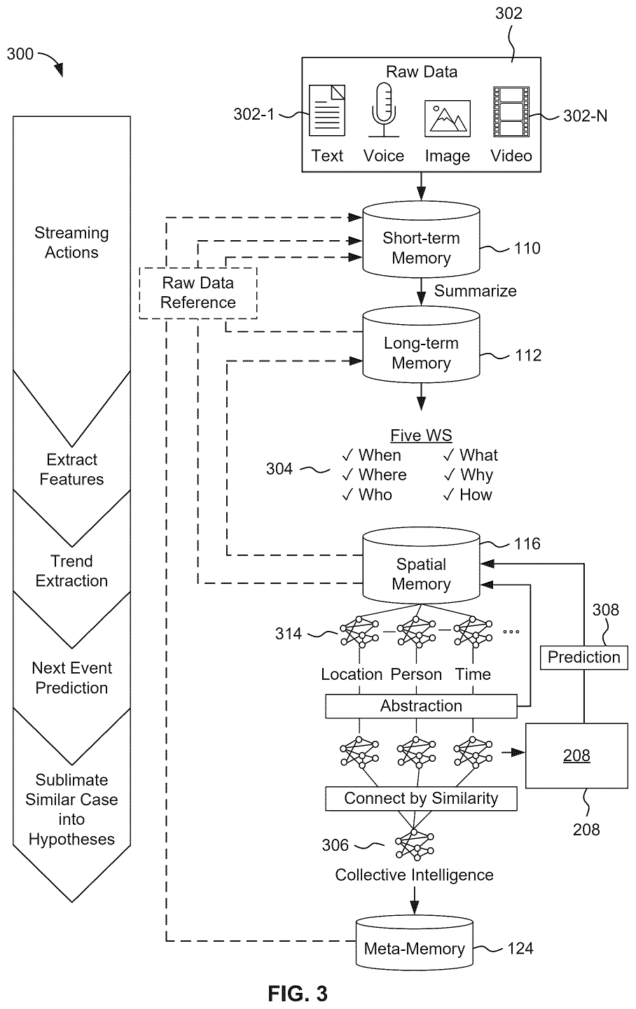

FIG. 3 is a detailed flowchart of an example method for extracting Five-Ws features, bundling trends, and predicting a subsequent event by means of a transformer-based model, according to the embodiment of this disclosure. For example, raw data is the text 302-1. The text 302-1 and data within the short-term memory 110 or short term memory data are summarized in the long-term memory 112. The long-term memory 112 includes features such as five W's 304. The five W's 304 are when, where, what, why, and who. The trends are extracted from the five W's 304. By passing the extracted trend to the transformer-based follow-up event prediction model 208, the follow-up event prediction 308 is obtained. After recording the follow-up event prediction 308 in spatial memory 114, it is converted into the hypothesis and verification data of collective knowledge 306 along with the historical data accumulated in spatial memory 114 and stored in the layered meta-memory 116.

For example, a product being out of stock on a certain day of the week. The out of stock product is clustered, for example pick up products that have the same trend as the products you hypothesized in advance. Data are sliced by vending machine, product, and time of day (for example processor slices the data weekly). A pattern of fluctuations in the number of inventories of the hypothesized product by time of day is created. A group of products that have a different trend from the target products of the prior hypothesis are picked but have similar tendencies.

Data are sliced by area, product, and time zone (for example processor slices the data weekly). A time-of-day inventory fluctuation pattern is created for each area and product, and pick up products that tend to be similar to the products covered by the pre-hypothesis. Products exhibiting different trends but similar tendencies to those specified in the pre-hypothesis are identified. Data is sliced by vending machine, product, and time zone such as on a weekly basis. Patterns of fluctuations in inventory levels by time of day are created for each vending machine and product. Based on these patterns, products with tendencies similar to those in the pre-hypothesis are selected.

A group of products with differing overall trends but similar tendencies to the target products of the prior hypothesis is identified. Data is segmented based on these similar-trend products selected in previous steps. Buyer attribute data is collected by target product, vending machine, and time zone. Information is gathered regarding when, where, and by whom the target product is purchased, along with data on stockouts and inventory stagnation. The data is further divided by product groupings that, despite differing in trend, share similarities with the pre-hypothesis target products. Buyer attributes are analyzed by target product, vending machine, and time of day. Additionally, information is collected concerning purchasing behaviour, out-of-stock timing, and stagnant inventory conditions.

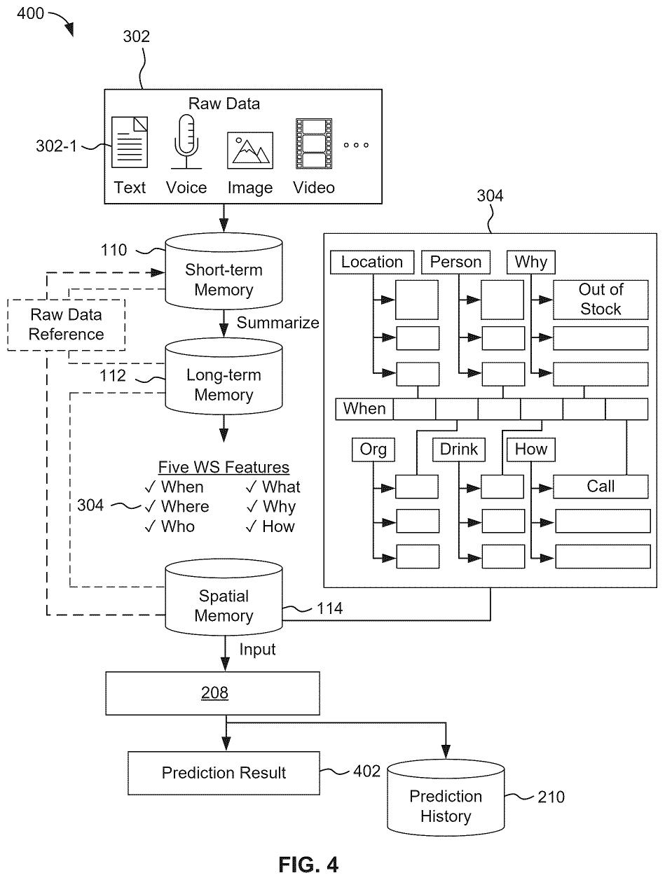

FIG. 4 illustrates a flowchart of a method 400 for storing prediction results in prediction history, in accordance with implementations of the present disclosure. For example, consider text as the raw data. The text is first registered in the short-term memory 110. Further, the long-term memory 112 may be created by summarizing and organizing the registered short-term memory 110. The long-term memory 112 may be organized by features such as the Five Ws (5W1H) to create the spatial memory 114. Non-limiting examples of the features are when, where, what, why, who, and how. Further, the trends may be extracted from the spatial memory 114 structured by the features. The extracted trends are bundled and the latest data from the spatial memory 114 may be inputted to the transformer-based subsequent event prediction model 208 to predict the subsequent event.

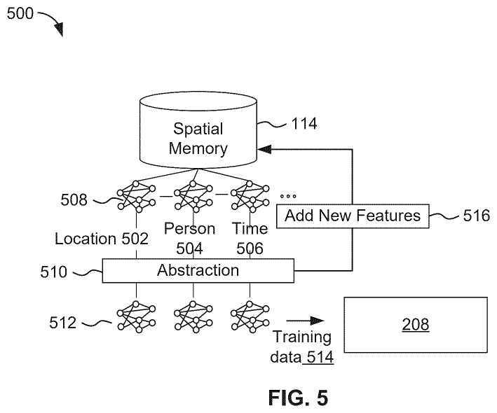

FIG. 5 illustrates a process flow an exemplary method 500 for bundling extracted trends into past memory structures to facilitate training of the transformer-based subsequent event prediction model 208, in accordance with embodiments of the present disclosure.

In an implementation, the trends are extracted from the spatial memory 114. The trends are structured according to feature dimensions such as, but not limited to, location (where), person (who), and time. Each trend represents a temporally evolving pattern derived from the multi-modal input data including textual logs, voice inputs, video data, and historical data.

Once the trends are extracted, the trends are subjected to time-series clustering 508 to identify groups of trends that exhibit similar temporal dynamics or behavioral signatures. The time-series clustering 508 serves to abstraction 510 of low-level signals into higher-level semantic groupings, enabling the identification of recurring scenarios, seasonal patterns, or cause-effect relationships.

The resulting clustered data 512 forms the basis for generating structured training data 514, which is subsequently used to train the transformer-based subsequent event prediction model 208. The transformer-based subsequent event prediction model 208 is implemented using a transformer-based architecture, leveraging both contextual embeddings and temporal dependencies to accurately predict likely future events or behaviors within the enterprise environment.

In an embodiment, during the time-series clustering 508, if new features 516 are discovered i.e., attributes that contribute significantly to the grouping of trends but are not previously part of the spatial memory feature set, such new features 516 are dynamically added to the spatial memory 114. For example, if a trend cluster is found to depend strongly on device type or weather condition, those features are incorporated into the spatial memory 114 as new classification axes, thereby resulting in dynamic expansion of the features (including “Five Ws”). The dynamic expansion of the “Five Ws” (Who, What, When, Where, Why) ensures that the system 100 evolves its dimensional understanding of enterprise events over time. As new contextual signals become relevant, the new contextual signals are incorporated into the trend abstraction pipeline, thereby enhancing the comprehensiveness of the predictive modeling process.

By continuously refining the spatial memory 114 and retraining the transformer based subsequent event prediction model 208 with updated trend groupings, self-improving predictive capabilities are improved. This architecture supports the generation of increasingly accurate and context-aware future event predictions, which are used to drive autonomous decision-making, enterprise task automation, or human-in-the-loop recommendations.

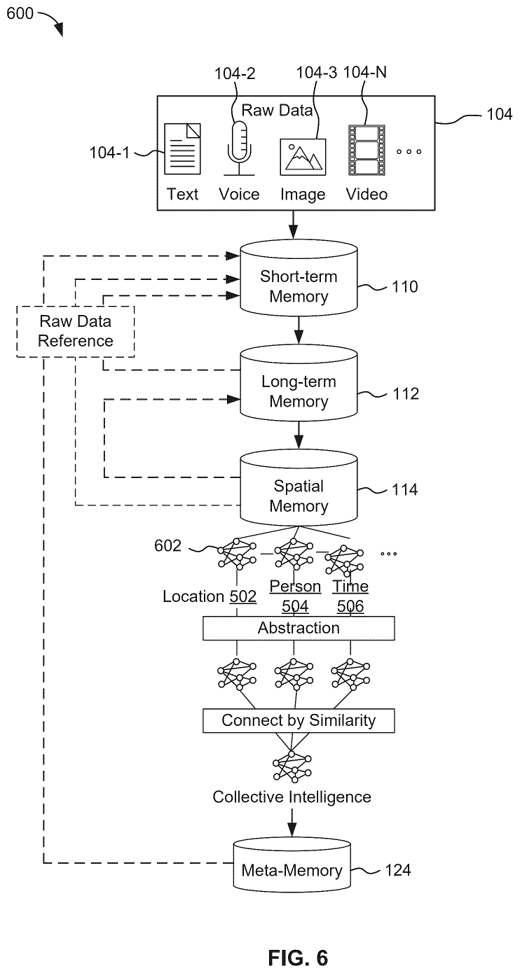

FIG. 6 is a process flow of an exemplary method 600 for transforming bundles of past trend data into structured hypotheses to create and refine the meta-memory 116, in accordance with embodiments of the present disclosure. In an implementation, the method 600 begins by accessing bundled trend data previously abstracted and clustered from the spatial memory 114, as described in conjunction with FIG. 5.

The trend bundles include recurring patterns extracted from the multimodal input data 104 and are categorized by dimensions such as location 502 (where), actor 504 (who), and time 506 (when), action (what), and motivation (why). The method 600 performs time-series clustering 602 across these trend bundles to identify similar historical sequences or behavioral groupings. The time-series clustering 602 allows the system 100 to recognize recurring phenomena that, although temporally or spatially separated, exhibit statistically or semantically analogous patterns. From the groupings, candidate hypotheses are generated automatically, which represent generalized causal or correlative statements. For example, a hypothesis may be: “People tend to buy soda when they exhibit signs of fatigue”. Each such hypothesis is stored as an unverified hypothesis within the meta-memory 116, which functions as a higher-order cognitive model designed to store abstract knowledge 604. The method 600 then proceeds to verify the validity of each unverified hypothesis using historical event sequences retained in the spatial memory 114. The verification involves cross-referencing the hypothesis against time-aligned, feature-rich data to assess support or contradiction based on actual past occurrences.

The hypotheses that are corroborated by the data are classified as verified hypotheses, while those that lack empirical support are classified as rejected hypotheses. Upon classification, the meta-memory 116 is updated accordingly. Further, the verified hypotheses are elevated in confidence and used as knowledge components to support downstream reasoning, prediction, or action initiation. Rejected hypotheses are retained for traceability but are flagged as invalidated, and over time, can be deprecated based on system heuristics or thresholds.

In addition, a structural feedback is applied to the spatial memory 114. For example, new feature dimensions associated with verified hypotheses (e.g., “fatigue” as a trigger) are added to the spatial memory 114, allowing future trends to incorporate and benefit from newly discovered causal factors. Conversely, the feature dimensions correlated exclusively with rejected hypotheses may be pruned from the spatial memory 114 after a rejection persistence threshold is met, thereby optimizing the memory model and reducing noise. By iteratively executing this process, the system builds the hierarchical meta-memory 116 that evolves over time through continuous learning and self-correction. The meta-memory 116 serves as a repository of collective intelligence, enabling the control system 102 to reason over abstract concepts, generalize across disparate data inputs, and adapt to dynamic enterprise environments.

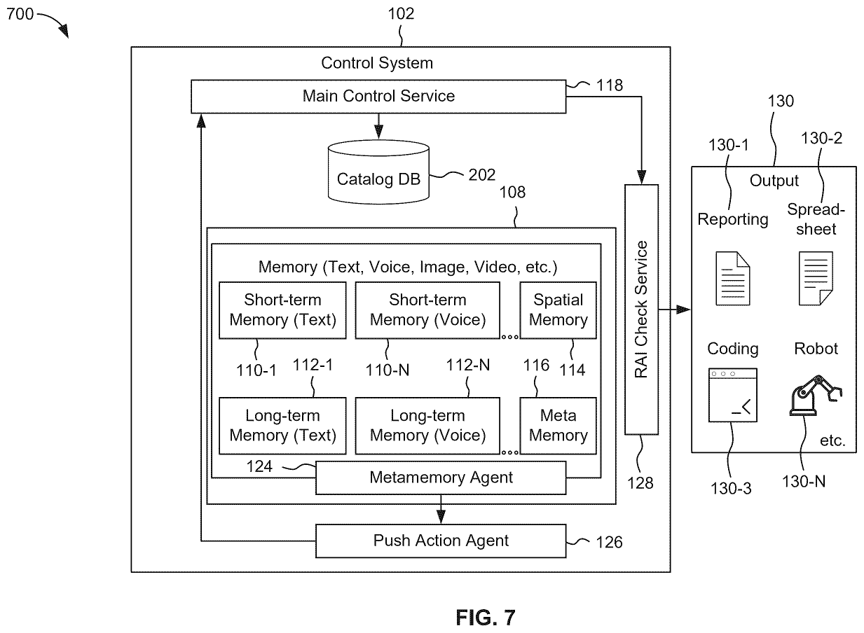

FIG. 7 is a process flow diagram of an exemplary computer-implemented method in which the push action agent 126 proactively prompts human intervention or automated response by leveraging verified hypotheses stored in the meta-memory 116 and corresponding structured events retained in the spatial memory 114 , in accordance with embodiments of the present disclosure. In one implementation, the method 700 is initiated when recurring event data such as repeated customer complaints or inventory shortages is accumulated in the spatial memory 114. This data is structured across multiple axes, including but not limited to location, product type, timestamp, and user behavior signals. Over time, consistent patterns emerging from this data are aggregated and abstracted into trend bundles, which are subsequently evaluated to generate hypotheses (as described in conjunction with FIGS. 5 and 6). Once a hypothesis is verified against historical patterns (e.g., “product X runs out every Friday evening, causing complaints”), it is promoted to a confirmed hypothesis within the meta-memory 116.

The push action agent 126 operates as a proactive decisioning component. Periodically or in response to triggers, the push action agent 126 queries the metamemory agent 124 to determine whether the latest structured data in the spatial memory 114 reflects a match to any confirmed hypotheses. For example, if current inventory and complaint data show signals similar to those associated with a known stock-out event, the metamemory agent 124 confirms that a hypothesis has been re-instantiated by real-time data. Upon receiving this confirmation, the push action agent 126 notifies the main control service 118, which evaluates whether the matched hypothesis warrants human attention or system-driven remediation. The evaluation is based on predefined thresholds, historical resolution success rates, and ethical or regulatory parameters stored in system policy memory. If action is warranted, the main control service 118 selects and executes an appropriate API or AI model from the catalog database 202, which may include logistics automation scripts, chatbot-based customer support escalation, supply chain adjustment logic, or alert generation for human supervisors. Following execution, the output 130 generated is subject to a Responsible AI (RAI) check service 128, which audits the result for compliance with ethical standards, fairness metrics, hallucination filtering, and security guidelines. Only if the output 130 passes this validation is it published or enacted through outputs 130-1..N, which may include messages, dashboards, control signals, or automated workflows. In one illustrative scenario, a vending machine at a specific location routinely runs out of a popular product on Friday evenings, triggering customer dissatisfaction. The control system 102 slices historical data by product type, vending machine ID, and temporal intervals. The control system 102 then structures this data to identify fluctuation patterns, which form the basis of a verified hypothesis such as: “Customers frequently complain about Product X shortage every Friday after 6 PM”. When this pattern appears again in new data, the push action agent 126 triggers an alert that prompts preemptive restocking via an API call to the logistics management system. Notably, if repeated application of the event prediction and push action mechanism leads to resolution of the previously recurring event (e.g., stock levels are consistently maintained and complaints cease), the associated event patterns gradually vanish from spatial memory reconstructions. Consequently, the confirmed hypothesis is demoted and marked for potential rejection upon reevaluation, ensuring that only active and relevant hypotheses persist in meta-memory 116. Furthermore, the transformer-based subsequent event prediction model 208 is continuously retrained using updated training data, which includes the evolving status of confirmed and rejected hypotheses.

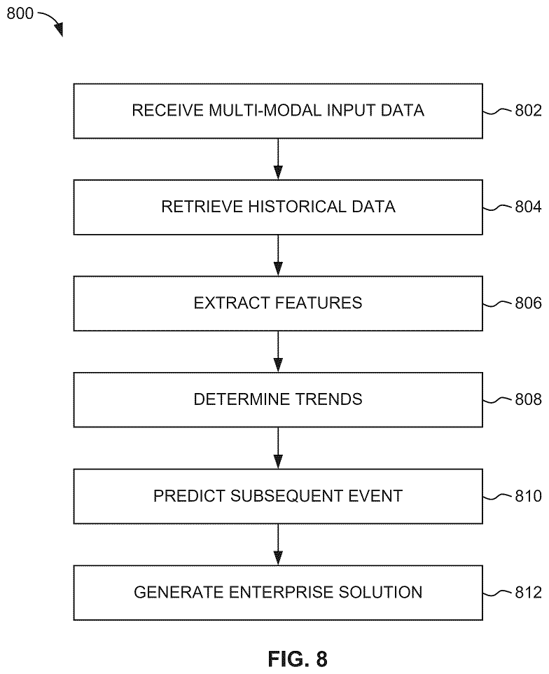

FIG. 8 is a flow diagram that presents an example computer implemented method 800 for generating enterprise outputs (also referenced to as enterprise solutions), in accordance with implementations of the present disclosure. In some implementations, the computer implemented method 800 may be executed by the processor of the control system 102, as described in relation to FIGS. 1-2. FIG. 8 is explained in conjunction with FIGS. 1-7.

At step 802, the computer implemented method 800 may include receiving the multi-modal input data 104 from various input data sources. The multi-modal input data 104 comprise one of text data, voice logs, image logs, video logs, and/or the like. The multi-modal data is preprocessed to generate structured data or summarized long term memory data. The short term memory data (raw data) is converted, using the LLM via the connectors 106, into one of a summarized long-term memory data and organized long-term memory data. For example, in an implementation, speech-to-text summary data and audio data pointers are extracted from the voice logs associated with the input data sources, using a speech recognition module. Context summary data and image data pointers are extracted from the image logs associated with the input data sources, using an image processing module. Context summary data and video data pointers are extracted from the video logs associated with the input data sources, using a video analysis module.

At step 804, the computer implemented method 800 may include retrieving historical data corresponding to an enterprise solution associated with historical inputs from connectors interfacing with a plurality of Artificial Intelligence (AI) models. The AI models include one of external generative artificial intelligence models, internal custom artificial intelligence models, external data sources, and internal enterprise data sources. At step 806, the computer implemented method 800 may include extracting features from the multi-modal input data and the historical data. The features include one of a temporal feature, a spatial feature, a contextual feature, a causal feature, and an entity-related attribute.

At step 808, the computer implemented method 800 may include determining trends from the extracted features associated with the multi-modal input data and the historical data. The trends include patterns corresponding to data fluctuations associated with the multi-modal input data. The trends are determined by structuring data based on one of a temporal attribute, a spatial attribute, and a contextual attribute. To determine the trends, in some implementations, an intention attribute is interpreted from the multi-modal input data received from the input sources. Further, an action plan is formulated based on the interpreted intention attribute and stored processing results of the short-term memory data and the long-term memory data. Thereafter, the formulated action plan id modified dynamically based on real-time feedback from external AI systems. Further, coordination is established with each external AI system from the AI systems to align the modified action plan. The modified action plan is executed based on the coordination with each of the external AI system and response data is obtained from the hippocampus agents (e.g., the hippocampus agent 122) associated with the each of the external AI system. After that output data including an ethical consideration data is generated, based on the executed action plan. The generated output data is validated by cross-referencing with the stored processing results and the obtained response.

In some implementations, to validate the output data, inconsistencies in the enterprise solution are detected. Further, the enterprise solution is corrected based on pre-defined ethical parameters and historical data patterns. In some implementations, the generated output data including the ethical consideration data is validated based on the executed action plan. The validated output data is analyzed for at least one of detect hallucination, a restrict harmful content, and filter sensitive information.

In some implementations, to determine the trends, the extracted features are segregated by one of time intervals, geographic areas, products, and entity identifiers. To segregate the features, groups of multi-modal input data are identified with similar data fluctuation patterns. The groups of multi-modal input data are corelated with the historical data. Trend consistency is validated based on the correlation. Once the features are segregated, a change in a state of the segregated features across the time intervals is aggregated into patterns. Further, key factors including one of time zones, locations, humans, and the products associated with the patterns are identified.

At step 810, the computer implemented method 800 may include predicting a subsequent event based on the determined trends using a transformer-based Large Language Model (LLM). The predicted subsequent event is stored in a spatial memory (e.g., the spatial memory 114).

At step 812, the computer implemented method 800 may include generating an enterprise solution based on the predicted subsequent event. The enterprise solution includes one of a report, a spreadsheet, a code, and a robotic process automation configuration.

Further, in some implementations, the long-term memory data is structured into a spatial memory using the LLM via the connectors 106. The spatial memory 114 is organized by features including one of time, location, person, and action. Further, trends are extracted from the historical data stored in the spatial memory and the features using time-series clustering. The extracted trends are used to train a transformer-based subsequent event prediction model 208 associated with the transformer-based LLM. The subsequent event is predicted based on the extracted trends and the multi-modal input data. Hypotheses are formulated and verified based on the extracted trends using the historical data stored in the spatial memory 114 to generate meta-memory data. An alert is transmitted to a user to take action based on the verified hypotheses and the predicted subsequent event.

To formulate and verify the plurality of hypotheses, candidate hypotheses are generated based on the extracted trends. The candidate hypotheses are cross-referenced with historical data patterns stored in the spatial memory 114. A confidence score is assigned to each of candidate hypotheses based on alignment with the historical data patterns.

The disclosure offers significant advantages by integrating the multi-modal input data such as text, voice, image, video, and memory streams with historical enterprise data to generate highly contextualized and intelligent enterprise solutions. Through advanced feature extraction and trend analysis across temporal, spatial, and contextual dimensions, the disclosure enables more accurate event prediction and decision-making. The inclusion of ethical validation, real-time coordination with external AI systems, and the use of meta-memory enhances reliability, compliance, and transparency. Furthermore, the disclosure provides ability to detect hallucinations, correct inconsistencies, and filter sensitive information ensures outputs are both trustworthy and actionable, making a robust framework for dynamic, data-driven enterprise automation and insight generation.

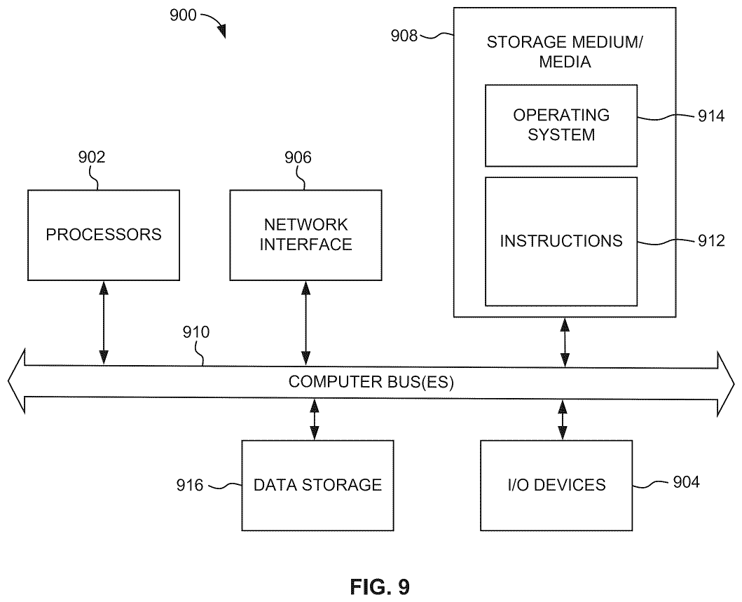

FIG. 9 depicts a computer system 900 that may be used to implement the system 100. More particularly, computing machines such as desktops, laptops, smartphones, tablets, and wearables which may be used for generating enterprise solutions. The computer system 900 may include additional components not shown and that some of the process components described may be removed and/or modified. In another example, the computer system 900 may be deployed on external-cloud platforms such as cloud, internal corporate cloud computing clusters, organizational computing resources, and/or the like.

The computer system 900 includes processor(s) 902, such as a central processing unit, an application specific integrated circuit (ASIC) or another type of processing circuit, input/output devices 904, such as a display, mouse keyboard, etc., a network interface 906, such as a Local Area Network (LAN), a wireless 802.11x LAN, a 3G or 4G or 5G mobile WAN or a WiMax WAN, and a storage medium/media 908. Each of these components may be operatively coupled to a computer bus 910. The storage medium/media 908 may be any suitable medium that participates in providing instructions to the processor(s) 902 for execution. For example, the storage medium/media 908 may be non-transitory or non-volatile medium, such as a magnetic disk or solid-state non-volatile memory or volatile medium such as RAM. The instructions or modules stored on the storage medium/media 908 may include machine-readable instructions 912 executed by the processor(s) 902 that cause the processor(s) 902 to perform the methods and functions of the system 100.

The system 100 may be implemented as software stored on a non-transitory processor-readable medium and executed by the processor(s) 902. For example, the storage medium/media 908 may store an operating system 914, such as MAC OS, MS WINDOWS, UNIX, or LINUX, and code, for the system 100. The operating system 914 may be multi-user, multiprocessing, multitasking, multithreading, real-time, and the like. For example, during runtime, the operating system 914 is running and the code for the system 100 is executed by the processor(s) 902.

The computer system 900 may include a data storage 916, which may include non-volatile data storage. The data storage 916 stores any data used or generated by the system 100.

The network interface 906 connects the computer system 900 to internal systems for example, via a LAN. Also, the network interface 906 may connect the computer system 900 to the Internet. For example, the computer system 900 may connect to web browsers and other external applications and systems via the network interface 906.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer also includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 902 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive multi-modal input data from a plurality of input data sources, wherein the multi-modal input data comprise at least one of text data, voice logs, image logs, and video logs;
retrieve historical data corresponding to an enterprise solution associated with a plurality of historical inputs from a plurality of connectors interfacing with a plurality of Artificial Intelligence (AI) models;
extract a plurality of features from the multi-modal input data and the historical data, wherein the plurality of features comprises at least one of a temporal feature, a spatial feature, a contextual feature, a causal feature, and an entity-related attribute;
determine a plurality of trends from the extracted plurality of features associated with the multi-modal input data and the historical data, wherein the plurality of trends comprises a plurality of patterns corresponding to a plurality of data fluctuations associated with the multi-modal input data, and wherein the plurality of trends is determined by structuring data based on at least one of a temporal attribute, a spatial attribute, and a contextual attribute;
predict a subsequent event based on the determined plurality of trends using a transformer-based Large Language Model (LLM), wherein the predicted subsequent event is stored in a spatial memory; and
generate at least one enterprise solution based on the predicted subsequent event, wherein the at least one enterprise solution comprises at least one of a report, a spreadsheet, a code, and a robotic process automation configuration.

2. The system of claim 1, wherein to determine the plurality of trends from the extracted plurality of features associated with the multi-modal input data and the historical data, the processor is further to:
interpret an intention attribute from the multi-modal input data received from the plurality of input data sources;
formulate an action plan based on the interpreted intention attribute and stored processing results of the short-term memory data and the long-term memory data;
modify dynamically, the formulated action plan based on real-time feedback from a plurality of external AI systems;
coordinate with each of the external AI system from the plurality of external AI systems to align on the modified action plan;
execute the modified action plan based on the coordination with each of the external AI system and obtain response data from hippocampus agents associated with the each of the external AI system;
generate output data comprising an ethical consideration data, based on the executed action plan; and
validate the generated output data by cross-referencing with the stored processing results and the obtained response.

3. The system of claim 2, wherein to validate the generated output, the processor is further to:
detect inconsistencies in the enterprise solution; and
correct the enterprise solution based on pre-defined ethical parameters and historical data patterns.

4. The system of claim 2, wherein the processor is further to:
validate the generated output data comprising the ethical consideration data, based on the executed action plan; and
analyze the validated output data for at least one of detect hallucination, a restrict harmful content, and filter sensitive information.

5. The system of claim 1, wherein to determine the plurality of trends, the processor is further to:
segregate the extracted plurality of features by at least one of a plurality of time intervals, a plurality of geographic areas, a plurality of products, and a plurality of entity identifiers;
aggregate a change in a state of the segregated plurality of features across the plurality of time intervals into the plurality of patterns; and
identify key factors comprising at least one of time zones, locations, humans, and the products associated with the plurality of patterns.

6. The system of claim 5, wherein to segregate the extracted plurality of features, the processor is further to:
identify a plurality of groups of multi-modal input data with similar data fluctuation patterns;
correlate the plurality of groups of multi-modal input data with the historical data; and
validate trend consistency based on the correlation.

7. The system of claim 1, wherein the processor is further to:
extract speech-to-text summary data and audio data pointers from the voice logs associated with the plurality of input data sources, using a speech recognition module;
extract context summary data and image data pointers from the image logs associated with the plurality of input data sources, using an image processing module; and
extract context summary data and video data pointers from the video logs associated with the plurality of input data sources, using a video analysis module.

8. The system of claim 1, wherein the processor is further to:
convert, using AI models via the plurality of connectors, short-term memory data into at least one of a summarized long-term memory data and organized long-term memory data;
structure the long-term memory data into a spatial memory using the LLM via the plurality of connectors, wherein the spatial memory is organized by a plurality of features comprising at least one of time, location, person, and action;
extract the plurality of trends from the historical data stored in the spatial memory and the plurality of features using time-series clustering, wherein the extracted plurality of trends is used to train a transformer-based subsequent event prediction model associated with the transformer-based LLM;
predict the subsequent event based on the extracted plurality of trends and the multi-modal input data;
formulate and verify a plurality of hypotheses based on the extracted plurality of trends using the historical data stored in the spatial memory to generate meta-memory data; and
alert a user to take action based on the verified plurality of hypotheses and the predicted subsequent event.

9. The system of claim 8, wherein to formulate and verify the plurality of hypotheses, the processor is further to:
generate a plurality of candidate hypotheses based on the extracted plurality of trends;
cross-reference the plurality of candidate hypotheses with historical data patterns stored in the spatial memory; and
assign a confidence score to each of the plurality of candidate hypotheses based on alignment with the historical data patterns.

10. The system of claim 1, wherein the plurality of AI models comprises at least one of external generative artificial intelligence models, internal custom artificial intelligence models, external data sources, and internal enterprise data sources.

11. A method comprising:
receiving, by the processor, multi-modal input data from a plurality of input data sources, wherein the plurality of input data sources comprises at least one of text data, voice logs, image logs and video logs;
retrieving, by the processor, historical data corresponding to an enterprise solution associated with a plurality of historical inputs from a plurality of connectors interfacing with a plurality of Artificial Intelligence (AI) models;
extracting, by the processor, a plurality of features from the multi-modal input data and the historical data, wherein the plurality of features comprises at least one of a temporal feature, a spatial feature, a contextual feature, a causal feature, and an entity-related attribute;
determining, by the processor, a plurality of trends from the extracted plurality of features associated with the multi-modal input data and the historical data, wherein the plurality of trends comprises a plurality of patterns corresponding to a plurality of data fluctuations associated with the multi-modal input data, wherein the plurality of trends is determined by structuring data based on at least one of a temporal attribute, a spatial attribute, and a contextual attribute;
predicting, by the processor, a subsequent event based on the determined plurality of trends using a transformer-based Large Language Model (LLM), wherein the predicted subsequent event is stored in a spatial memory; and
generating, by the processor, at least one enterprise solution based on the predicted subsequent event, wherein the at least one enterprise solution comprises at least one of a report, a spreadsheet, a code, and a robotic process automation configuration.

12. The method of claim 11, wherein determining the plurality of trends from the extracted plurality of features associated with the multi-modal input data and the historical data, further comprises:
interpreting, by the processor, an intention attribute from the multi-modal input data received from the plurality of input sources;
formulating, by the processor, an action plan based on the interpreted intention attribute and a stored processing results of the short-term memory data and the long-term memory data;
modifying dynamically, by the processor, the formulated action plan based on real-time feedback from a plurality of external AI systems;
coordinating, by the processor, with each of the external AI system from the plurality of external AI systems to align on the modified action plan;
executing, by the processor, the modified action plan based on the coordination with each of the external AI system and obtain response data from hippocampus agents associated with the each of the external AI system;
generating, by the processor, output data comprising an ethical consideration data, based on the executed action plan; and
validating, by the processor, the generated output data by cross-referencing with the stored processing results and the obtained response.

13. The method of claim 12, wherein validating the generated output, further comprises:
detecting, by the processor, inconsistencies in the enterprise solution; and
correcting, by the processor, the enterprise solution based on pre-defined ethical parameters and historical data patterns.

14. The method of claim 12, further comprises:
validating, by the processor, the generated output data comprising the ethical consideration data, based on the executed action plan; and
analyzing, by the processor, the validated output data for at least one of detect hallucination, a restrict harmful content, and filter sensitive information.

15. The method of claim 11, wherein determining the plurality of trends, further comprises:
segregating, by the processor, the extracted plurality of features by at least one of a plurality of time intervals, a plurality of geographic areas, a plurality of products, and a plurality of entity identifiers;
aggregating, by the processor, a change in a state of the segregated plurality of features across the plurality of time intervals into the plurality of patterns; and
identifying, by the processor, key factors comprising at least one of time zones, locations, humans, and the products associated with the plurality of patterns.

16. The method of claim 15, wherein segregating the extracted plurality of features, further comprises:
identifying, by the processor, a plurality of groups of multi-modal input data with similar data fluctuation patterns;
correlating, by the processor, the plurality of groups of multi-modal input data with the historical data; and
validating, by the processor, trend consistency based on the correlation.

17. The method of claim 11, further comprises:
extracting, by the processor, speech-to-text summary data and audio data pointers from the voice logs associated with the plurality of input data sources, using a speech recognition module;
extracting, by the processor, context summary data and image data pointers from the image logs associated with the plurality of input data sources, using an image processing module; and
extracting, by the processor, context summary data and video data pointers from the video logs associated with the plurality of input data sources, using a video analysis module.

18. The method of claim 11, further comprises:
converting, by the processor, using the plurality of AI models via a plurality of connectors, short-term memory data into at least one of summarized long-term memory data and organized long-term memory data;
structuring, by the processor, the long-term memory data into a spatial memory using the LLM via the plurality of connectors, wherein the spatial memory is organized by a plurality of features comprising at least one of time, location, person, and action;
extracting, by the processor, a plurality of trends from historical data stored in the spatial memory and the plurality of features using time-series clustering;
training, by the processor, a transformer-based subsequent event prediction model associated with the transformer-based LLM using the extracted plurality of trends;
predicting, by the processor, a subsequent event based on the extracted plurality of trends and multi-modal input data, wherein the multi-modal input data comprises at least one of text data, voice data, image data, and video data;
formulating and verifying, by the processor, a plurality of hypotheses based on the extracted plurality of trends using the historical data stored in the spatial memory to generate meta-memory data; and
alerting, by the processor, a user to take action based on the verified plurality of hypotheses and the predicted subsequent event.

19. The method of claim 18, wherein formulating and verifying the plurality of hypotheses further comprises:
generating, by the processor, a plurality of candidate hypotheses based on the extracted plurality of trends;
cross-referencing, by the processor, the plurality of candidate hypotheses with historical data patterns stored in the spatial memory; and
assigning, by the processor, a confidence score to each of the plurality of candidate hypotheses based on alignment with the historical data patterns.

20. A non-transitory computer-readable medium comprising processor-executable instructions that cause a processor to:
receive multi-modal input data from a plurality of input data sources, wherein the plurality of input data sources comprises at least one of text data, voice logs, image logs and video logs;
retrieve historical data corresponding to an enterprise solution associated with a plurality of historical inputs from a plurality of connectors interfacing with a plurality of Artificial Intelligence (AI) models;
extract a plurality of features from the multi-modal input data and the historical data, wherein the plurality of features comprises at least one of a temporal feature, a spatial feature, a contextual feature, a causal feature, and an entity-related attribute;
determine a plurality of trends from the extracted plurality of features associated with the multi-modal input data and the historical data, wherein the plurality of trends comprises a plurality of patterns corresponding to a plurality of data fluctuations associated with the multi-modal input data;
predict a subsequent event based on the determined plurality of trends using a transformer-based Large Language Model (LLM), wherein the predicted subsequent event is stored in a spatial memory; and
generate at least one enterprise solution based on the predicted subsequent event, wherein the at least one enterprise solution comprises at least one of a report, a spreadsheet, a code, and a robotic process automation configuration.
